(19) United States
(12) Patent Application Publication
(10) Pub. No.: US 2004/0094640 A1
(43) Pub. Date: May 20, 2004

(54) Fuel injection valve

(76) Inventors: Hubert Stier, Vaihingen/Enz (DE); Elmar Okrent, Remseck (DE); Ulrich Dobler, Remseck (DE)

Correspondence Address: KENYON & KENYON, ONE BROADWAY, NEW YORK, NY, 10004, US

(21) Appl. No.: 10/250,531

(22) PCT Filed: Aug. 23, 2002
(86) PCT No.: PCT/DE02/03093

(30) Foreign Application Priority Data
Oct. 31, 2001 (DE) 101 53 630.5

(51) Int. Cl. B05B 1/30

(52) U.S. Cl. 239/584

(57) ABSTRACT

A fuel injector (1) for the direct injection of fuel into the combustion chamber of an internal combustion engine has a piezoelectric actuator (2) which is encapsulated in an actuator housing (3); a valve needle (9) which is in operative connection with the actuator and on which a valve-closure member (11) is formed which forms a sealing seat together with a valve-seat surface (13); and a nozzle body (12) into which the actuator housing (3) is able to be inserted. The actuator housing (3) and the nozzle body (12) are sealed by a common connecting part (4), the connecting part (4) having a first and a second diameter step (19; 20).

### FIELD OF THE INVENTION

The present invention is directed to a fuel injector.

### BACKGROUND INFORMATION

For instance, from German Patent No. 195 34 445, a fuel injector is known which has an axially movable valve needle in a nozzle body. The valve needle is able to be actuated by a piezoelectric actuator and held in the closing position by a compression spring. The fuel is supplied by an external source at a freely adjustable pressure. The valve needle has a central bore. The piezoactuator concentrically surrounds the valve needle and is sealed from the fuel pressure by sealing surfaces.

Disadvantageous in the fuel injector known from German Patent No. 195 34 445 is, in particular, that the encapsulation of the piezoelectric actuator, which must be sealed from the corrosive fuel and the pressure of the fuel, is labor intensive and expensive. In addition, it is difficult to compensate for thermal longitudinal changes in the actuator in order to avoid subsequent malfunctions of the fuel injector.

### SUMMARY OF THE INVENTION

In contrast, the fuel injector configured according to the present invention has the advantage over the related art that the piezoelectric or magnetostrictive actuator is situated in an actuator housing, and the nozzle body, in which the actuator housing is located, may be jointly sealed by a connecting part having graduated diameter steps that are able to be connected to the actuator housing and the nozzle body.

Furthermore, it is advantageous that the steps have different radial diameters, thereby setting the actuator housing and the nozzle body apart, so that the fuel may be conveyed to the sealing seat without bores in the housing.

The piezoelectric actuator is advantageously acted upon by a closing spring, which is situated between an end plate of the actuator and a shoulder of the actuator housing.

Moreover, it is advantageous that the connecting part can be produced in a simple and inexpensive manner by turning.

### BRIEF DESCRIPTION OF THE DRAWING

FIG. 1 shows a schematic section through an exemplary embodiment of a fuel injector configured according to the present invention.

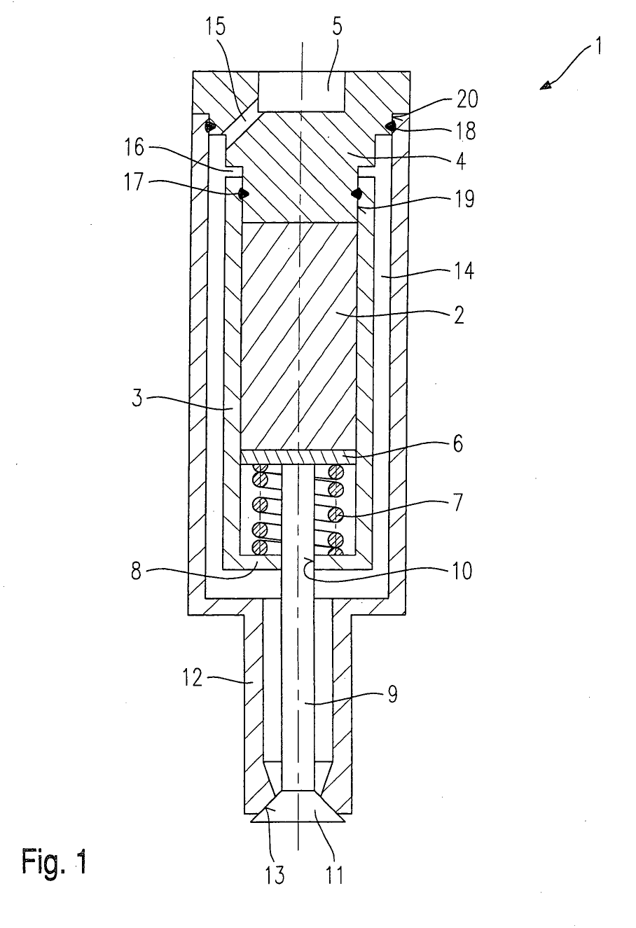

### DETAILED DESCRIPTION

An exemplary embodiment of a fuel injector 1 according to the present invention is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 includes a piezoelectric actuator 2 which is encapsulated in an actuator housing 3. On the inflow side, actuator housing 3 is sealed by a connecting part 4 which may be produced in a cost-effective manner by turning, for instance. Connecting part 4 has a fuel inflow 5 and an electrical connection (not shown further) for actuating piezoelectric actuator 2.

Piezoelectric actuator 2 is supported downstream on an end plate 6 at whose other side a closing spring 7 is positioned. Closing spring 7 is braced between end plate 6 and a shoulder 8 of actuator housing 3. It acts upon a valve needle 9, which is in force-locking connection to end plate 6, with a closing force that keeps fuel injector 1 closed in the de-energized state of piezoelectric actuator 2.

Valve needle 9 penetrates closing spring 7 and a recess 10 in shoulder 8 of actuator housing 3. At a downstream end of valve needle 9 is a valve-closure member 11 which forms a sealing seat together with a valve-seat surface 13 formed on a nozzle body 12. Inside nozzle body 12 is actuator housing 3, with connecting part 4 inserted therein on the inflow side. Nozzle body 12 is slipped onto connecting part 4 as well.

Connecting part 4 has a first diameter step 19 onto which actuator housing 3 is slipped, and a second diameter step 20 onto which nozzle body 12 is slipped. Due to the fact that the radial diameter of first diameter step 19 is smaller than that of second diameter step 20, an annular clearance space 14 is formed between actuator housing 3 and nozzle body 12, through which the fuel supplied via fuel supply 5 is guided to the sealing seat. At least one fuel channel 15 is formed in connecting part 4 for a connection between fuel supply 5 and clearance space 14.

The described encapsulation of piezoelectric actuator 2 in actuator housing 3 and the joint sealing of actuator housing 3 and nozzle body 12 by connecting part 4 is characterized, in particular, by its simple and cost-effective construction. The sealing may be implemented without additional elastomer seals. Connecting part 4 is able to be produced in a simple manner by turning and, in addition to fuel supply 5, may also accommodate the electrical line for exciting piezoelectric actuator 2, so that bores in the housing may be dispensed with. Waste heat generated during the operation of piezoelectric actuator 2, may also be carried away by the fuel flowing past actuator housing 3 and used, for instance, to preheat the fuel.

To adjust the spring force of closing spring 7, actuator housing 3 is slipped over connecting part 4 until the point is reached where the required spring force is attained, adjusting gap 16 being set in the process. Subsequently, actuator housing 3 is joined to connecting part 4, for instance, by a welding seam 17. Nozzle body 12 is also connected to connecting part 4, for instance, also by a welding seam 18.

In response to piezoelectric actuator 2 being energized by an electric voltage able to be externally supplied, it expands in a discharge direction of the fuel, counter to the spring force of closing spring 7. This moves end plate 6 with valve needle 9, which is in operative connection therewith, in the discharge direction as well. Valve-closure member 11, which is connected to valve needle 9 by force-locking, lifts off from valve-sealing seat 13, thereby spray-discharging fuel into the combustion chamber (not shown further) of an internal combustion engine.

If the voltage energizing piezoelectric actuator 2 is switched off, actuator 2 contracts. End plate 6 is relieved of pressure, and the force of closing spring 7 presses it counter to the discharge direction of the fuel. Valve needle 9, which is in force-locking connection to end plate 6, also moves counter to the discharge direction, so that valve-closure member 11 sets down on valve-seat surface 13 and fuel injector 1 is closed.

The present invention is not limited to the exemplary embodiment shown and is also suitable, for instance, for fuel injectors 1 having magnetostrictive actuators or also to inwardly opening fuel injectors 1.

What is claimed is:

1. A fuel injector (1) for the direct injection of fuel into the combustion chamber of an internal combustion engine, having a piezoelectric or magnetostrictive actuator (2) which is encapsulated in an actuator housing (3); a valve needle (9), which is in operative connection with the actuator, a valve-closure member (11) being formed on the valve needle (9) which forms a sealing seat together with a valve-seat surface (13); and a nozzle body (12), wherein the actuator housing (3) is inserted in the nozzle body (12) and the actuator housing (3) and the nozzle body (12) are sealed by a joint connecting part (4), the connecting part (4) having a first diameter step (19) which is connected to the actuator housing (3), and a second diameter step (20), which is connected to the nozzle body (20).

2. The fuel injector as recited in claim 1,
wherein the actuator housing (3) is slipped over the first diameter step (19).

3. The fuel injector as recited in claim 1,
wherein the nozzle body (12) is slipped over the second diameter step (20).

4. The fuel injector as recited in claim 2 or 3,
wherein the second diameter step (20) has a larger diameter than the first diameter step (19).

5. The fuel injector as recited in claim 4,
wherein, between the nozzle body (12) and the actuator housing (3), an annular clearance space (14) is formed which is used to supply the fuel to the sealing seat.

6. The fuel injector as recited in claim 5,
wherein the connecting part (4) has a fuel supply (5) which is connected to the clearance space (14) via a fuel channel (15).

7. The fuel injector as recited in one of claims 1 through 6,
wherein, on the inflow side, the actuator (2) is braced on the connecting part (4).

8. The fuel injector as recited in one of claims 1 through 7,
wherein, on the discharge side, the actuator (2) is braced on an end plate (6).

9. The fuel injector as recited in claim 8,
wherein the end plate (6) is in force-locking connection to the valve needle (9).

10. The fuel injector as recited in claim 8 or 9,
wherein a closing spring (7) is situated between the end plate (6) and a shoulder (8) of the actuator housing (3).

11. The fuel injector as recited in one of claims 1 through 10,
wherein the actuator housing (3) is joined to the connecting part (4) via a welding seam (17).

12. The fuel injector as recited in one of claims 1 through 11,
wherein the nozzle body (12) is joined to the connecting part (4) via a welding seam (18).

13. The fuel injector as recited in one of claims 1 through 12,
wherein the connecting part (4) is produced by turning.
